(19) United States
(12) Patent Application Publication
(10) Pub. No.: US 2022/0081494 A1
(43) Pub. Date: Mar. 17, 2022

(54) PROCESS FOR PRODUCING FLUOROPOLYMERS USING 2-ALKOXYACETATE SURFACTANTS

(71) Applicants: Gujarat Fluorochemicals Limited, Noida (IN); Indian Institute of Technology Delhi, New Delhi (IN)

(72) Inventors: Bhuvanesh GUPTA, New Delhi (IN); Bishwajit Santosh Bhattacharya, Noida (IN); Rajeev Chauhan, Noida (IN); Jitendra Kumar Rathour, Noida (IN); Gaurav Kumar, Noida (IN); Chetna Verma, New Delhi (IN)

(21) Appl. No.: 17/417,575

(22) PCT Filed: Dec. 23, 2019
(86) PCT No.: PCT/IN2019/050952

§ 371 Date: Jun. 23, 2021

(30) Foreign Application Priority Data
Dec. 24, 2018 (IN) 201811048944
Jan. 25, 2019 (IN) 201911003128

(51) Int. Cl. C08F 2/26; C08F 114/24

(52) U.S. Cl. CPC C08F 2/26; C08F 114/24

(57) ABSTRACT

The present invention relates to a process for the polymerization of fluoromonomers in an aqueous medium, said process comprising the steps of: forming an aqueous emulsion comprising a 2-Alkoxy acetate surfactant and fluoromonomer in a reactor; and initiating polymerization of said fluoromonomer by adding an initiator into the reaction mixture. Preferably, the surfactant used in the instant process is either Sodium 2-[(2-hexyldecyl)oxy] acetate or Sodium-2-dodecyloxyacetate.

### FIELD OF THE INVENTION

The present invention pertains to a process for polymerizing fluoromonomers using non-fluorinated surfactants. More particularly, the present invention relates to a process for aqueous polymerization using 2-Alkoxy acetate surfactants.

### BACKGROUND OF THE INVENTION

Fluoropolymers attract a lot of attention due to their extreme chemical resistance and favorable dielectric properties. They are generally synthesized from alkenes in which one or more hydrogen atoms have been replaced by fluorine atom. The most important members of this class of polymers are polytetrafluoroethylene (PTFE), aqueous PTFE, fine particle PTFE, polychlorotrifluoroethylene (PCTFE), polyvinyl fluoride (PVF), fluorinated ethylene polymer (FEP), perfluoroalkoxy polymer (PFA) and polyvinylidene fluoride (PVDF). They are primarily manufactured via heterogeneous polymerization reactions including aqueous systems. Generally, the reaction requires a monomer and a radical initiator in a suitable aqueous reaction medium. Aqueous polymerization of fluorine containing monomers generally requires a surfactant capable of emulsifying both the reactants and the reaction products for the duration of the polymerization reaction. As discussed below, the surfactant of choice in the synthesis of fluoropolymers is generally a perfluoro surfactant or a partially fluorinated surfactant. The most frequently used perfluoroalkyl surfactant in the production of fluoropolymers is ammonium perfluorooctanoate (AFPO).

U.S. Pat. No. 7,932,333 B2 discloses a process comprising polymerizing at least one fluorinated monomer in an aqueous medium containing initiator and polymerization agent to form an aqueous dispersion of particles of fluoropolymer, the polymerization agent comprising fluoropolyether acid or salt thereof having a number average molecular weight of at least about 800 g/mol; and fluoropolyether acid or salt surfactant. U.S. Pat. No. 7,777,075 B2 provides a fluoroether carboxylic acid which is represented by the general formula (I): Rf¹OCHFCF₂ORf²COOM. The fluoroether carboxylic acid can be suitably used as a surfactant. The patent also discloses a method of fluoropolymer production and an aqueous fluoropolymer dispersion, using the fluoroether carboxylic acid as a surfactant.

U.S. Pat. No. 7,897,682 B2 discloses a process for polymerizing at least one fluorinated monomer in an aqueous medium in the presence of initiator and polymerization agent to form an aqueous dispersion of particles of fluoropolymer having a fluoropolymer solids content of at least about 10% by weight. The polymerization agent is a combination of fluoropolyether acid or salt thereof and hydrocarbon surfactant.

The aforestated fluorosurfactants are expensive, specialized materials, difficult to synthesize and because of their high stability persist in the environment for a long time. Their persistence in the environment leads to bioaccumulation in living organisms. Hence, they are now under the watch of environmental and regulatory authorities. Perfluorooctane sulfonate (PFOS) was added to list of chemicals under the Stockholm Convention on persistent organic pollutants in 2009, and almost all use of PFOS is banned in Europe, with some exemptions. Final regulations have not yet been promulgated for polyfluoroalkyl substances (PFAS); current criteria for PFAS are typically in the form of guidance or advisory levels. According to the advisory, any substance may not contain PFOS above the limit of 0.001% by weight, EU 757/2010. In the U.S., PFOS manufacturing was voluntarily phased out in 2002.

A process for the polymerization of fluoromonomers, which uses a nonfluorinated surfactant would solve the aforestated issues of persistence in the eco-system and bio-accumulation of fluorosurfactants, and would lead to cheaper and simplified processes. Consequently, there is a need to explore the use of non-fluorinated surfactants in the aqueous polymerization of fluoromonomers.

### OBJECTIVES OF THE INVENTION

The main objective of the invention is to overcome the aforestated problems in the prior art.

The other objective of the present invention is to provide a process for the aqueous polymerization of fluoromonomers using non-fluorinated surfactants.

Yet another objective of the present invention is to provide a process for the aqueous polymerization of fluoropolymers using non-fluorinated 2-Alkoxy acetate surfactants.

It is yet another objective of the invention to provide a simplified one step process for the preparation of fluoropolymers.

It is another objective of the invention to provide a process for preparing fluoropolymers, which is devoid of the step of passivating the surfactants and nucleation.

It is another objective of the invention to provide a process for preparing fluoropolymers, with optimum particle size.

Yet another objective of the present invention is to provide a fluoropolymer dispersion comprising non-fluorinated 2-Alkoxy acetate surfactants.

It is another objective of the present invention to provide a fluoropolymer resin obtained by aqueous polymerization using non-fluorinated 2-Alkoxy acetate surfactants.

### SUMMARY OF THE INVENTION

The present invention relates to a process for aqueous polymerization of fluoromonomers using non-fluorinated surfactants, particularly 2-Alkoxy acetate surfactants.

In accordance with an embodiment of the invention, there is provided a process for preparing a fluoropolymer in an aqueous medium by a polymerization reaction, said process comprising the steps of:
(a) forming an aqueous emulsion comprising a 2-Alkoxy acetate surfactant and a fluoromonomer in a reactor or a reaction vessel; and
(b) initiating polymerization of said fluoromonomer by adding an initiator.

In accordance with another embodiment, step (a) comprises the steps of:
i. adding deionized water and optionally paraffin wax into the reactor;
ii. adding the 2-Alkoxy acetate surfactant in one shot into the reactor; and
iii. adding fluoromonomer into the reactor and agitating the reaction mixture.

In accordance with yet another embodiment of the invention, step (b) comprises adding the initiator in one shot into the reactor.

In accordance with yet another embodiment of the invention, the 2-Alkoxy acetate surfactant has a structure of R—O—CH₃—COOM, wherein R is a hydrocarbon group, and M is a monovalent cation selected from the group consisting of hydrogen ions, alkali metal ions, and ammonium ions. Preferably, R is an alkyl group containing 6 to 21 carbon atoms. Further, M is preferably selected from the group consisting of potassium, sodium and ammonium.

In a preferred embodiment, 2-Alkoxy acetate surfactant is either a compound of formula 1 or formula 2.

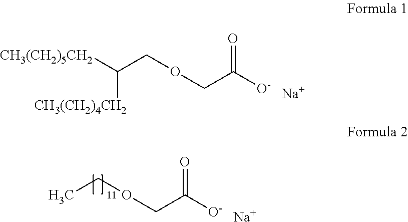

In accordance with a further embodiment of the invention, the aqueous emulsion comprises an initiator, for initiating the polymerization reaction, the initiator being selected from the group consisting of Ammonium Persulphate (APS), Disuccinic Acid Peroxide (DSAP) and combinations thereof. The aqueous emulsion of the present invention may optionally comprise stabilizing agents such as paraffin wax.

In accordance with an embodiment of the invention, the reaction temperature is in the range of 20 to 160° C., preferably 60 to 130° C., and more preferably 75 to 95° C.

In accordance with still another embodiment of the invention, the reaction pressure ranges from 2 to 200 bar. Preferably, the pressure in the reaction vessel or reactor is 24 bar.

In accordance with yet another embodiment, the reaction mixture is agitated at 50 rpm.

In accordance with a further embodiment, the concentration of the surfactant in the reaction mixture ranges from 1000 to 7,000 ppm, and preferably 3000 to 4000 ppm, based on the weight of the aqueous dispersion.

In accordance with an embodiment of the invention, the concentration of the initiator ranges from 50 to 2000 ppm, preferably from 50 to 400 ppm and more preferably from 150 to 400 ppm, based on the weight of the aqueous dispersion.

In accordance with yet another embodiment, the solid content of the fluoropolymer, obtained by the polymerization reaction ranges from 15 to 25% and more preferably from 18 to 25%.

In accordance with still yet another embodiment, the particle size of the fluoropolymer obtained by the polymerization reaction ranges from 180 nm to 240 nm.

In accordance with an embodiment, the polymerization reaction time ranges from 60 to 160 minutes.

In accordance with an embodiment, the fluoromonomer is selected from the group consisting of tetrafluoroethylene, chlorotrifluoroethylene, vinyl fluoride, vinylidene fluoride, hexafluoropropylene, perfluoropropylvinylether, perfluorobutylethylene and combinations thereof.

### BRIEF DESCRIPTION OF ACCOMPANYING DRAWINGS

FIG. 1: is a flowchart of the process of polymerization of the present invention.

### DETAILED DESCRIPTION OF THE INVENTION

Discussed below are some representative embodiments of the present invention. The invention in its broader aspects is not limited to the specific details and representative methods. Illustrative examples are described in this section in connection with the embodiments and methods provided.

It is to be noted that, as used in the specification, the singular forms “a,” “an,” and “the” include plural referents unless the context clearly dictates otherwise. Thus, for example, reference to a composition containing “a compound” includes a mixture of two or more compounds. It should also be noted that the term “‘or” is generally employed in its sense including “and/or” unless the content clearly dictates otherwise.

The expression of various quantities in terms of “%” or “% w/w” means the percentage by weight of the total solution or composition unless otherwise specified.

The present invention, in all its aspects, is described in detail as follows:

The present invention relates to a process for preparing a fluoropolymer in an aqueous medium, comprising:
(a) forming an aqueous emulsion comprising a 2-Alkoxy acetate surfactant and fluoromonomer in a reactor or reaction vessel; and
(b) initiating polymerization of said fluoromonomer by adding an initiator.

Surfactant

The term “surfactant” means a type of molecule which has both hydrophobic and hydrophilic, portions, which allows it to stabilize and disperse hydrophobic molecules and aggregates of hydrophobic molecules in aqueous systems. A preferred group of surfactants for fluoropolymer synthesis according to the embodiments of the present invention includes non-fluorinated carboxylate surfactants, more preferably 2-Alkoxy acetate surfactants. The 2-Alkoxy acetate surfactant has a structure of R—O—CH₃—COOM, wherein R is a hydrocarbon group, M is a monovalent cation selected from the group consisting of hydrogen ions, alkali metal ions, and ammonium ions. More preferably, R is an alkyl group containing 6 to 21 carbon atoms. Preferably, M can be potassium, sodium or ammonium. In a particularly preferred embodiment, the 2-alkoxy acetate surfactant is represented by the formula 1. Compound of formula 1 is also known by the chemical name-Sodium-2-[(2-hexyldecyl)oxy] acetate.

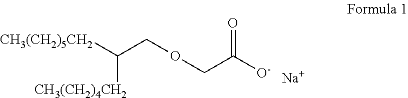

In another particularly preferred embodiment, the 2-alkoxy acetate surfactant is represented by the formula 2. Compound of formula 2, is also known by the chemical name Sodium-2-dodecylacetate.

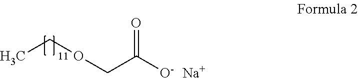

Fluoromonomers

The term “fluoromonomer” or the expression “fluorinated monomer” means a polymerizable alkene which contains at least one fluorine atom, fluoroalkyl group, or fluoroalkoxy group attached to the double bond of the alkene that undergoes polymerization. The term “fluoropolymer” means a polymer formed by the polymerization of at least one fluoromonomer, and it is inclusive of homopolymers, copolymers, terpolymers and higher polymers. Specific examples of suitable fluoromonomers include, without limitation, vinyl fluoride, vinylidine fluoride (VDF), 1-fluoro-1-chloro-ethylene, perfluoropropylvinylether, trifluoroethylene (TrFE), tetrafluoroethylene (TFE), hexafluoropropene (HFP), chlorotrifluoroethylene (CTFE), 1-chloro-2,2-difluoroethylene, perfluoromethyl vinylether (PMVE), etc. Preferably, the fluoromonomer is tetrafluoroethylene (TFE) and the fluoropolymer obtained as a result of the polymerization reaction is polytetrafluoroethylene (PTFE).

The aqueous emulsion comprises an initiator for initiating the polymerization process.

Initiators

The term “initiator” and the expressions “radical initiator” and “free radical initiator” refer to a chemical that is capable of providing a source of free radicals, either induced spontaneously, or by exposure to heat or light. Examples of suitable initiators include peroxides, peroxydicarbonates and azo compounds. “Initiators” also includes redox systems useful in providing a source of free radicals. The term “radical” and the expression “free radical” refer to a chemical species that contains at least one unpaired electron. The radical initiator is added to the reaction mixture in an amount sufficient to initiate and maintain the polymerization reaction rate. Preferably, the addition of the initiator into the reaction vessel or reactor is carried out in one shot. The radical initiator may comprise a persulfate salt, such as sodium persulfate, potassium persulfate, or ammonium persulfate. Alternatively, the radical initiator may comprise a redox system. “Redox system” is understood by a person skilled in the art to mean a system comprising an oxidizing agent, a reducing agent and optionally, a promoter as an electron transfer medium. In a preferred embodiment, the radical initiator is either Disuccinic Acid Peroxide (DSAP), Ammonium Persulphate (APS), Potassium Persulfate (KPS) or combinations thereof.

Polymerization Conditions

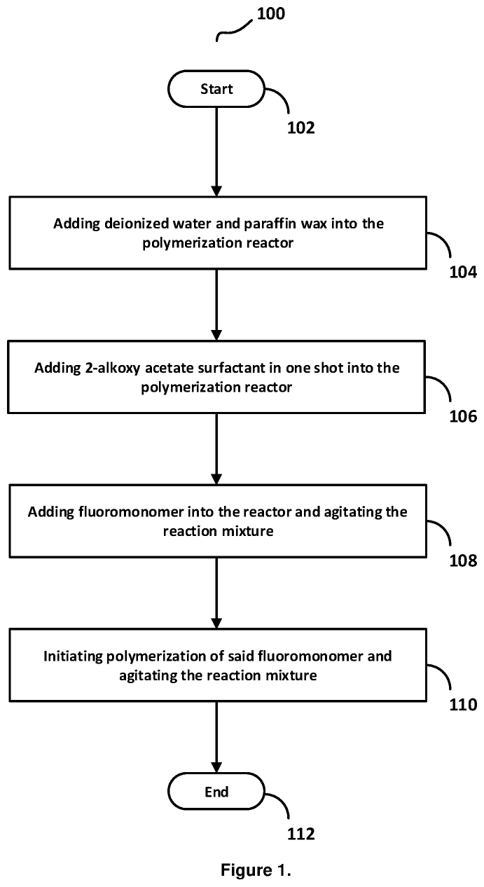

The process parameters for carrying out the polymerization of the fluoromonomers in accordance with the present invention, illustrated in FIG. 1, 100, are as follows. The temperature used for polymerization may vary, for example, from 20 to 160° C., depending on the initiator system chosen and the reactivity of the fluoromonomer (s) selected. Preferably, the polymerization is carried out at a temperature in the range from 60 to 130° C., and more preferably, in a range of 75 to 95° C.

The pressure used for polymerization may vary from 2-200 bar, depending on the reaction equipment, the initiator system, and the monomer selection. In a preferred embodiment the reaction is carried out at a pressure of 24 bar.

The polymerization occurs under stirring or agitation. The stirring may be constant, or may be varied to optimize process conditions during the course of the polymerization. In one embodiment, both multiple stirring speeds and multiple temperatures are used for controlling the reaction.

According to an embodiment of the process of the invention referring to FIG. 1, in step 104, a pressurized polymerization reactor equipped with a stirrer and heat control means is charged with water, preferably deionized water, non-fluorinated 2-Alkoxy acetate surfactant in accordance with the invention and at least one fluoromonomer. The surfactant content ranges from 1000 ppm to 7000 ppm and preferably from 3000 to 4000 ppm, based on the weight of aqueous dispersion. In a preferred embodiment, the surfactant content is 3125 ppm, based on the weight of the aqueous fluoropolymer dispersion. Preferably, in step 106, the surfactant is added in one shot into the reaction vessel. The mixture may optionally contain paraffin wax. In step 108, the reactor is then heated up to the reaction temperature, and the pressure is increased by adding fluoromonomer. Thereafter, initiators are added into the reaction vessel to initiate the polymerization reaction in step 110. Preferably the initiator is introduced into the reaction vessel in one shot. The initiator concentration ranges from 50 to 2000 ppm and preferably from 50 to 400 ppm. In a preferred embodiment, the initiator concentration ranges from 150 to 400 ppm, based on the weight of the aqueous dispersion. Prior to introduction of the surfactant and monomer or monomers into the reaction vessel, air is preferably removed from the reactor in order to obtain an oxygen-free environment for the polymerization reaction. Preferably, the oxygen is removed from the reaction vessel until its concentration is less than 10 ppm. The reactor may also be purged with a neutral gas such as, for example, nitrogen or argon.

Upon completion of the polymerization reaction, the reactor is brought to ambient temperature and the residual unreacted monomer is vented to atmospheric pressure. The aqueous reaction medium containing the fluoropolymer is then recovered from the reaction vessel. Preferably, the solid content ranges from 15 to 25%, and more preferably from 18 to 25%. The particle size of the fluoropolymer particles ranges from 180 nm to 240 nm.

The present invention is more particularly described in the following examples that are intended as illustrations only, since numerous modifications and variations within the scope of the present invention will be apparent to those of skill in the art. Unless otherwise noted, all parts, percentages, and ratios reported in the following example are on a weight basis, and all reagents used in the example were obtained or are available from the chemical suppliers.

The following example illustrates the basic methodology and versatility of the present invention.

### Example 1

The polymerization process was carried out in a 150 L horizontal reactor, with six blade agitator. 96 L of de-ionized water, and 4 kg of paraffin wax were added into the reactor. Oxygen was removed from the reactor until its concentration was less than 10 ppm. After that, the surfactant, molecule of formula 1, also known as Sodium 2-[(2-hexyldecyl)oxy] acetate, 3125 ppm, was added in one shot into the reactor. Thereafter, the addition of Tetrafluoroethylene (TFE) resulted in an increase in the pressure to 24 bar and the temperature was increased to 80 to 95° C. After attaining the aforesaid pressure and temperature, a solution comprising an initiator Ammonium Persulphate (APS), was added so that the final concentration of initiator in the reaction mixture was 275 ppm. Upon completion of the polymerization reaction, the reactor is brought to ambient temperature and the residual unreacted monomer is vented to atmospheric pressure. The aqueous reaction medium containing the fluoropolymer is then recovered from the reaction vessel. Examples 2 to 5 were also carried out in an identical manner and the ingredients and reaction parameters of Examples 1 to 5 are illustrated in Table 1 below. The latex particle size of the polymer was determined by—Dynamic Laser light scattering for analysis of particle size using a Nano particle Analyzer—HORIBA SZ-100. Although example 1 pertains to the polymerization of tetrafluoroethylene, the process may be applied to any monomer selected from the group consisting of tetrafluoroethylene, chlorotrifluoroethylene, vinyl fluoride, vinylidene fluoride, hexafluoropropylene, perfluoropropylvinylether, perfluorobutylethylene and combinations thereof. All parameters were derived in accordance with ASTM D 4895.

TABLE 1

| Ingredients/ | | | | | | |
|---|---|---|---|---|---|---|
| Reaction | | | | | | |
| Parameters | Units | Example-1 | Example-2 | Example-3 | Example-4 | Example-5 |
| Di-Ionized Water | Kg | 96 | 96 | 96 | 96 | 96 |
| Wax | Kg | 4 | 4 | 4 | 4 | 4 |
| 02 Content in the | ppm | ≤10 | ≤10 | ≤10 | ≤10 | ≤10 |
| System | | | | | | |
| Agitation | RPM | 50 | 50 | 50 | 50 | 50 |
| Reaction Pressure | Bar | 24 | 24 | 24 | 24 | 24 |
| Non-fluorinated | ppm | 3125 | 3125 | 3125 | 3125 | 3125 |
| surfactant | | | | | | |
| Total APS | ppm | 275 | 200 | 200 | 300 | 400 |
| Succinic Acid | g | 32.62 | 32.62 | 32.62 | 32.62 | 32.62 |
| Reaction Start | ° C. | 80 | 91 | 85 | 90 | 90 |
| Temperature | | | | | | |
| Total | Kg | 24 | 24 | 24 | 24 | 24 |
| Tetrafluoroethylene | | | | | | |
| (TFE)consumption | | | | | | |
| Reaction End | ° C. | 85.12 | 80.20 | 81.67 | 80.15 | 80.62 |
| Temperature | | | | | | |
| Total Reaction | min | 80 | 75 | 70 | 75 | 66 |
| Time | | | | | | |
| Latex | % | 20.56 | 21.58 | 22.67 | 22.15 | 22.00 |
| Concentration | | | | | | |
| Latex Particle size | nm | 225.2 | 203 | 215 | 210 | 206 |
| pH | | 3.01 | 3.52 | 3.88 | 3.75 | 3.12 |
| Solid Content | % | 22.48 | 20.31 | 21.66 | 22.15 | 22.69 |
| Standard Specific | | 2.185 | 2.176 | 2.189 | 2.178 | 2.189 |
| Gravity | | | | | | |
| Tensile Strength | psi | 25.16 | 26.11 | 27.23 | 25.98 | 25.97 |
| Elongation | % | 241.4 | 240.2 | 268.1 | 278.2 | 231.3 |
| Melting Point | ° C. | 341.76 | 341.73 | 343.05 | 343.51 | 344.09 |

### Example 6

The polymerization process was carried out in a 150 L reactor. 96 L of de-ionized water, and 4 kg of paraffin wax were added into the reactor. Oxygen was removed from the reactor until its concentration was less than 10 ppm. After that, the surfactant, molecule of formula 2, also known as Sodium Salt of 2-dodecyloxyacetic acid (Sodium-2-dodecyloxyacetate), 3125 ppm, was added in one shot into the reactor. Thereafter, the addition of Tetrafluoroethylene (TFE) resulted in an increase in the pressure to 24 bar and the temperature was increased to 80 to 95° C. After attaining the aforesaid pressure and temperature, a solution comprising an initiator, Disuccinic Acid Peroxide (DSAP), was added so that the final concentration of initiator in the reaction mixture was 156 ppm. Upon completion of the polymerization reaction, the reactor is brought to ambient temperature and the residual unreacted monomer is vented to atmospheric pressure. The aqueous reaction medium containing the fluoropolymer is then recovered from the reaction vessel. Examples 7 to 9 were also carried out in an identical manner and the ingredients and reaction parameters of Examples 6 to 9 are illustrated in Table 2 below. Although example 6 pertains to the polymerization of tetrafluoroethylene, the process may be applied to any monomer selected from the group consisting of tetrafluoroethylene, chlorotrifluoroethylene, vinyl fluoride, vinylidene fluoride, hexafluoropropylene, perfluoropropylvinylether, perfluorobutylethylene and combinations thereof.

TABLE 2

| Ingredients/ | | | | | |
|---|---|---|---|---|---|
| Reaction Parameters | Units | Example-6 | Example-7 | Example-8 | Example-9 |
| De-ionized water | kg | 96 | 96 | 96 | 96 |
| Wax | kg | 4 | 4 | 4 | 4 |
| O₂ content in the | ppm | ≤10 | ≤10 | ≤10 | ≤10 |
| system | | | | | |
| Agitation | rpm | 50 | 50 | 50 | 50 |
| Reaction pressure | bar | 24 | 24 | 24 | 24 |
| Non-fluorinated | ppm | 3125 | 3125 | 3125 | 3125 |
| surfactant | | | | | |
| Total DSAP | ppm | 156 | 187 | 187 | 187 |
| Succinic acid | g | 32.62 | 32.62 | 32.62 | 32.62 |
| Polymerization | | | | | |
| Reaction Start | ° C. | 82.04 | 84.12 | 83.71 | 83.5 |
| Temperature | | | | | |
| Total tetrafluoroethylene | kg | 24 | 24 | 24 | 23 |
| (TFE) consumption | | | | | |
| Reaction end | ° C. | 81.51 | 90.62 | 89.94 | 90.06 |
| temperature | | | | | |
| Total Reaction Time | min | 75 | 131 | 157 | 156 |
| Latex Concentration | % | 21.40 | 22.48 | 20.84 | 20.43 |
| Latex particle size (LPS) | nm | 226.3 | 203.1 | 228.3 | 217.8 |
| pH | | 3.25 | 3.22 | 3.30 | 3.25 |
| Solid Content | % | 21.46 | 22.52 | 20.90 | 20.53 |
| Standard Specific | | 2.193 | 2.181 | 2.181 | 2.182 |
| Gravity (SSG) | | | | | |
| Tensile strength | psi | 25.09 | 27.93 | 29.71 | 26.20 |
| Elongation | % | 230.1 | 246.3 | 267.0 | 233.7 |
| Melting Point | (° C.) | 343.54 | 343.69 | 342.7 | 342.51 |

The invention may be embodied in other specific forms without departing from the spirit or essential characteristics thereof. The present embodiments are therefore to be considered in all respects as illustrative and not restrictive.

### Example 10

The polymerization process was carried out in a 150 L reactor. 83 L of de-ionized water with 160 PPM of sodium pyro-phosphate as a buffer is added to the reactor. Oxygen was removed from the reactor until its concentration was less than 10 ppm. After that, the surfactant, molecule of formula 1, also known as Sodium Salt of 2-dodecyloxyacetic acid (Sodium-2-dodecyloxyacetate), 4200 ppm, was added in one shot into the reactor. Thereafter, the addition of 2.4 kg Tetrafluoroethylene (TFE), 5.4 kg Hexafluoropropylene (HFP) and 60 g perfluoropropylvinyl ether (PPVE) resulted in an increase in the pressure to 22 bar and the temperature was increased to 90° C. After attaining the aforesaid pressure and temperature, a solution comprising initiators Potassium persulfate and ammonium persulfate (1% solution), was added at a starting rate rate of 15 ml/min, gradually reduced to 6 ml/min. 29 PPM ethane gas was added as chain transfer agent after the reaction kicks off as indicated by a pressure drop of 0.5 bar. Upon completion of the polymerization reaction after metering of 27.1 kg TFE and 2.4 kg HFP in 400 minutes, the reactor is brought to ambient temperature and the residual unreacted monomer is vented to atmospheric pressure. The resulting polymer latex had a solid content of 27% by weight with a primary particle size of 234.2 nm. The latex particle size of the polymer was determined by—Dynamic Laser light scattering for analysis of particle size using a Nano particle Analyzer—HORIBA SZ-100. The resulting polymer powder after coagulation had the following properties: MFR (Melt Flow Rate): 26 g/10 min (372° C.; 5 kg load); Melting Temperature: 280.6° C.; Enthalpy: 27.6 J/g. All properties were derived in accordance with ASTM D 2116.

### Example 11

The polymerization process was carried out in a 150 L reactor. 77 L of de-ionized water with 135 PPM of sodium pyro-phosphate as a buffer is added to the reactor. Oxygen was removed from the reactor until its concentration was less than 10 ppm. After that, the surfactant, molecule of formula 1, also known as Sodium Salt of 2-dodecyloxyacetic acid (Sodium-2-dodecyloxyacetate), 4500 ppm, was added in one shot into the reactor. Thereafter, the addition of 1.3 kg Tetrafluoroethylene (TFE) and 5.0 kg Hexafluoropropylene (HFP) resulted in an increase in the pressure to 22 bar and the temperature was increased to 94° C. After attaining the aforesaid pressure and temperature, a solution comprising initiators Potassium persulfate and ammonium persulfate (1% solution), was added at a starting rate of 15 ml/min, and gradually reduced to 9 ml/min. 59 PPM ethane gas was added as chain transfer agent after the reaction kicks off as indicated by a pressure drop of 0.5 bar. Upon completion of the polymerization reaction, after metering of 27.10 kg TFE and 2.94 kg HFP in 430 minutes, the reactor was brought to ambient temperature and the residual unreacted monomer was vented to atmospheric pressure. The resulting polymer latex had a solid content of 29% by weight with a primary particle size of 235.2 nm. The latex particle size of the polymer was determined by—Dynamic Laser light scattering for analysis of particle size using a Nano particle Analyzer—HORIBA SZ-100. The resulting polymer powder after coagulation had the following properties: MFR: 24 g/10 min (372° C.; 5 kg load); Melting Temperature: 284.3° C.; Enthalpy: 24.1 J/g. All properties were derived in accordance with ASTM D 2116.

The invention may be embodied in other specific forms without departing from the spirit or essential characteristics thereof. The present embodiments are therefore to be considered in all respects as illustrative and not restrictive.

We claim:

1. A process for preparing a fluoropolymer in an aqueous medium, comprising:
(a) forming an aqueous emulsion comprising a 2-Alkoxy acetate surfactant and a fluoromonomer in a reactor; and
(b) initiating polymerization of said fluoromonomer by adding an initiator.

2. The process as claimed in claim 1, wherein step (a) comprises the steps of:
i. adding deionized water and optionally paraffin wax into the reactor;
ii. adding the 2-Alkoxy acetate surfactant in one shot into the reactor; and
iii. adding fluoromonomer into the reactor and agitating the reaction mixture.

3. The process as claimed in claim 1, wherein step (b) comprises adding the initiator in one shot into the reactor.

4. The process as claimed in claim 1, wherein the 2-Alkoxy acetate surfactant has a structure of R—O—CH₃—COOM, wherein R is a hydrocarbon group, and M is a monovalent cation selected from the group consisting of hydrogen ions, alkali metal ions, and ammonium ions.

5. The process as claimed in claim 4, wherein R is an alkyl group containing 6 to 21 carbon atoms.

6. The process as claimed in claim 4, wherein M is selected from the group consisting of potassium, sodium and ammonium.

7. The process as claimed in claim 1, wherein the 2-Alkoxy acetate surfactant is represented by formula 1.

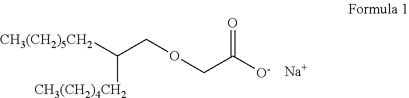

8. The process as claimed in claim 1, wherein the 2-Alkoxy acetate surfactant is represented by formula 2.

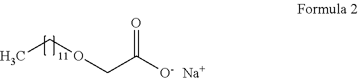

9. The process as claimed in claim 1, wherein the aqueous emulsion comprises an initiator, for initiating the polymerization process, the initiator being selected from the group consisting of Ammonium Persulphate (APS), Disuccinic Acid Peroxide (DSAP) and combinations thereof.

10. The process as claimed in claim 2, wherein the aqueous emulsion comprises stabilizing agents such as paraffin wax.

11. The process as claimed in claim 1, wherein the reaction temperature is in the range of 20 to 160° C., preferably 60 to 130° C., and more preferably 75 to 95° C.

12. The process as claimed in claim 1, wherein the reaction pressure ranges from 2 to 200 bar.

13. The process as claimed in claim 1, wherein the reaction pressure is 24 bar.

14. The process as claimed in claim 1, wherein the reaction mixture is agitated at 50 rpm.

15. The process as claimed in claim 1, wherein the concentration of the surfactant in the reaction mixture ranges from 1000 to 7000 ppm, and preferably 3000 to 4000 ppm.

16. The process as claimed in claim 1, wherein the concentration of the surfactant in the reaction mixture is 3125 ppm.

17. The process as claimed in claim 3, wherein the concentration of the initiator ranges from 50 to 2000 ppm, preferably from 50 to 400 ppm and more preferably from 150 to 400 ppm.

18. The process as claimed in claim 1, wherein the solid content of the fluoropolymer ranges from 15 to 25% and more preferably from 18 to 25%.

19. The process as claimed in claim 1, wherein the particle size of the fluoropolymer ranges from 180 nm to 240 nm.

20. The process as claimed in claim 1, wherein the reaction time ranges from 60 to 160 minutes.

21. The process as claimed in claim 1, wherein the fluoromonomer is selected from the group consisting of tetrafluoroethylene, chlorotrifluoroethylene, vinyl fluoride, vinylidene fluoride, hexafluoropropylene, perfluoropropylvinylether, perfluorobutylethylene and combinations thereof.
